(19) United States
(12) Patent Application Publication
(10) Pub. No.: US 2012/0233896 A1
(43) Pub. Date: Sep. 20, 2012

(54) FOREARM SLEEVE FOR SPORTS FANS

(76) Inventor: Kenny Johnson, San Diego, CA (US)

(21) Appl. No.: 12/792,875

(22) Filed: Jun. 3, 2010

(51) Int. Cl. G09F 21/02

(52) U.S. Cl. 40/586

(57) ABSTRACT

A hollow conical shaped forearm sleeve for sliding onto a user's forearm. The top end and bottom end of an elastic fabric are sewn together to form the forearm sleeve. A printed sports image representative of a sports team is printed onto the forearm sleeve. Also, an autograph receiving area is located on the forearm sleeve. In a preferred embodiment, the name of the promoter of a sports event is printed onto the forearm sleeve. In a preferred embodiment the elastic fiber is a spandex/cotton blend. Also, in a preferred embodiment the forearm sleeve is given away as a give-away item at a sports event.

The present invention relates to sports gear and sports memorabilia, and in particular, to sports gear and memorabilia for sports fans to wear.

### BACKGROUND OF THE INVENTION

Today we live in a sports obsessed society with successful athletes enjoying celebrity status on the same or even greater level than famous movie stars. Individuals pay high ticket prices to go to a professional or college sports event to see their favorite teams and athletes. In addition to profits from ticket sales, other profits are made from the sale of food and beverages at the games. Furthermore, sports teams, stadiums, promoters and advertisers rely on the sale of sports memorabilia for income.

Often promoters and advertisers will advertise that certain promotional items will be handed out to fans attending a sports event. For example, it might be advertised that all fans in attendance will receive a free back pack with the team logo. Or, all fans in attendance will receive a free bobble head doll or wall clock, each with the team logo. Other prior art items sold or given away at sporting events include: caps, jerseys, shorts, flags and pennants.

However, these items often are only utilized the day of the game and then find themselves thrown in the trash or in a box up in the attic.

Autograph books are also highly utilized at sports events. Fans will often show up early to a sports event hoping to spot an athlete for an autograph prior to the start of the game.

What is needed is a better sports memorabilia item that can be sold or given-away to sports fans.

### SUMMARY OF THE INVENTION

The present invention provides a hollow conical shaped forearm sleeve for sliding onto a user's forearm. The top end and bottom end of an elastic fabric are sewn together to form the forearm sleeve. A printed sports image representative of a sports team is printed onto the forearm sleeve. Also, an autograph receiving area is located on the forearm sleeve. In a preferred embodiment, the name of the promoter of a sports event is printed onto the forearm sleeve. In a preferred embodiment the elastic fiber is a spandex/cotton blend. Also, in a preferred embodiment the forearm sleeve is given away as a give-away item at a sports event.

### BRIEF DESCRIPTION OF THE DRAWINGS

FIG. 1 shows a preferred elastic fabric.

FIG. 2 shows images printed onto said preferred elastic fabric.

FIG. 3 shows a preferred forearm sleeve.

FIG. 4 shows a user wearing a preferred forearm sleeve.

FIG. 5 shows fans at a sporting event wearing preferred forearm sleeves.

### DETAILED DESCRIPTION OF THE PREFERRED EMBODIMENTS

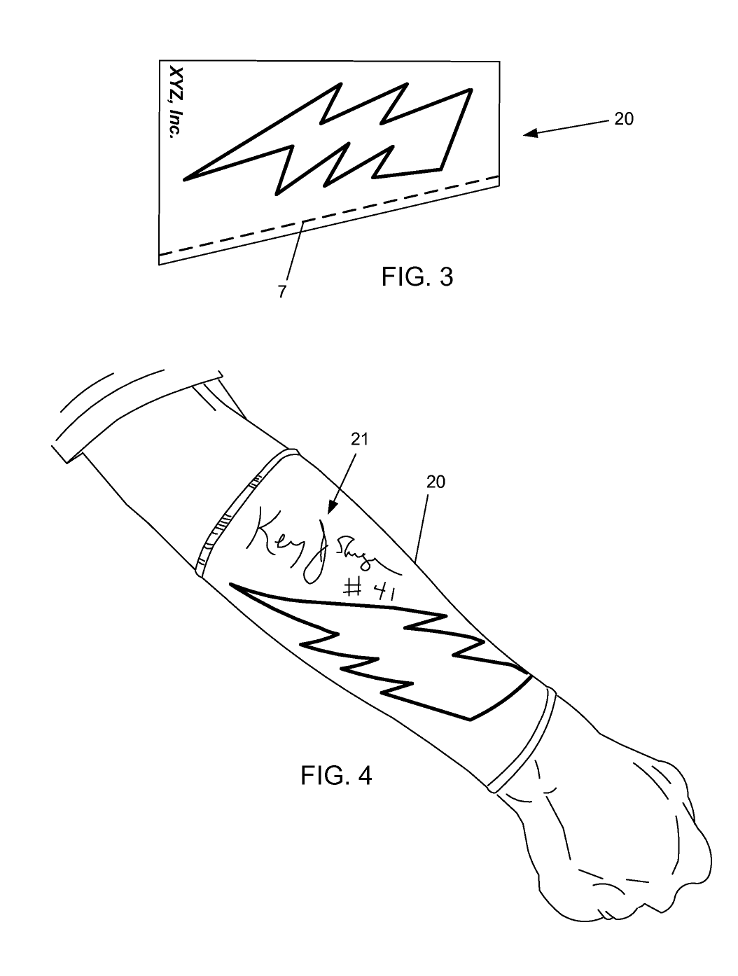

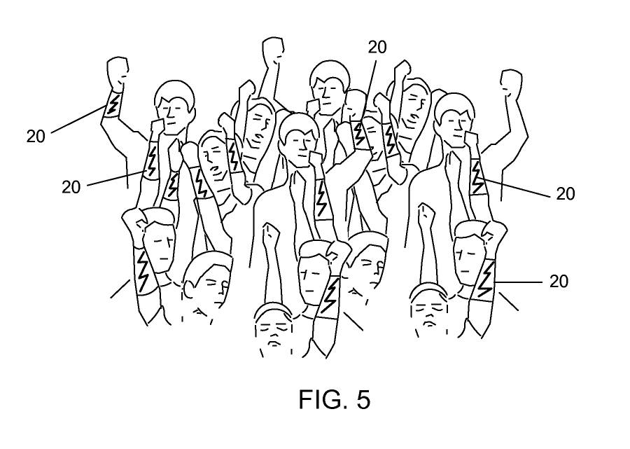

Forearm sleeve 20 is worn on a person's forearm as shown in FIG. 4. In a preferred embodiment, forearm sleeve 20 is handed out to sports fans attending a professional sporting event as a give-away product. Forearm sleeve 20 is attractive and preferably includes the logo of the fans' team for which he is cheering. Forearm sleeve is easily slid onto the wearer's forearm and warn during the game, as shown in FIG. 5. Forearm sleeve 20 preferably is fabricated from a smooth spandex/cotton blend that provides an excellent surface for receiving an autograph 21 (FIG. 4).

### Preferred Method of Making a Forearm Sleeve

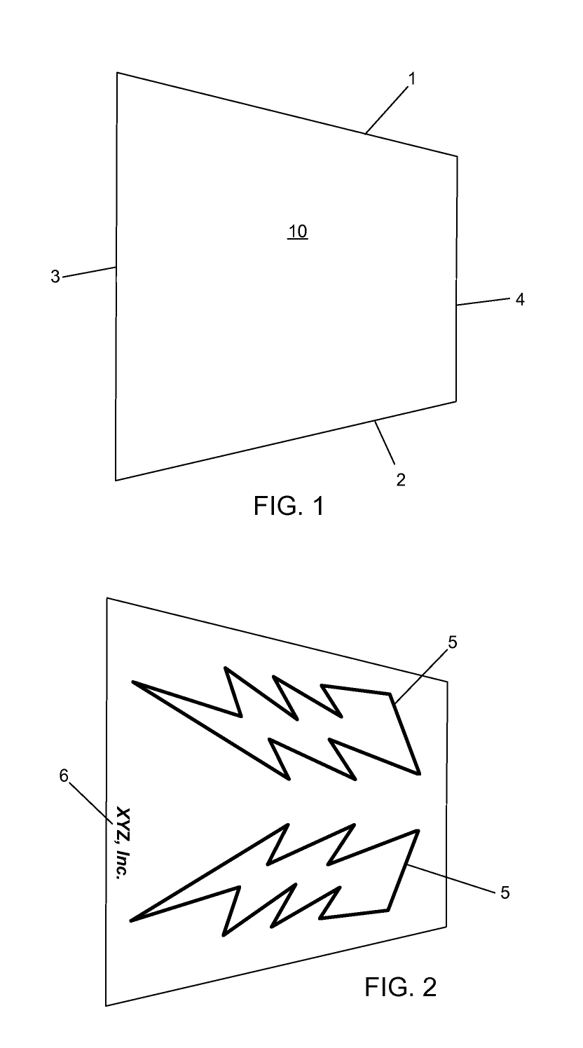

In FIG. 1, fabric section 10 has been cut in the shape as shown from a sheet of spandex/cotton blend fabric. In a preferred embodiment, top edge 1 and bottom edge 2 are each approximately 8 inches in length. Left side 3 is approximately 10 inches and right side 4 is approximately 6 inches.

In FIG. 2, sports team emblem 5 has been printed onto fabric section 10. For the example shown in FIG. 2, forearm sleeve 20 is being handed out at a San Diego Chargers® football game and the promoter of the game is the San Diego Chargers® team. Also, name 6 of the maker of forearm sleeve 20 has printed onto fabric section 10. For example, in FIG. 2 XYZ, Inc. is the manufacturer of forearm sleeve 20. Accordingly, XYZ, Inc. has printed its name onto fabric section 10 as a trademark.

To form forearm sleeve 20, fabric section 10 is folded over so that top edge 1 is flush with bottom edge 2. Top edge 1 and bottom edge 2 are then sewn together utilizing threads 7 to form a hollow, conical shaped tube for receiving a user's forearm, as shown in FIG. 3 and FIG. 4.

### Using a Preferred Forearm Sleeve

In FIG. 4, the user has slid forearm sleeve 20 onto his forearm. He is now ready to attend the sporting event. In the preferred embodiment, shown in FIG. 4, the user has obtained an autograph from one of the players at the sporting event. Preferably, the user can now continue to wear forearm sleeve when ever he wants. He can wear it to other games or around his neighborhood on game day. He can also continue to obtain additional autographs.

### Repeat Advertising

From a promoter's or advertiser's perspective, paying for a promotion once but having the promoter's name or logo seen multiple times is a significant competitive advantage. Accordingly, forearm sleeve 20 is washable and reusable. Therefore, sports fans are able to wear forearm sleeve 20 to multiple games and around town on game days or any other time that they want to.

### Easy to Carry and Inexpensive to Produce

Forearm sleeve 20 is easy to carry and easy to slide over the forearm. It is very simple to manufacture and inexpensive to mass produce.

### Forearm Sleeve is Compatible with Other Sports Fan Products

Forearm sleeve 20 compliments other sports fan products currently in existence. For example, users of forearm sleeve 20 will still want to use their caps, jersey, shorts, flags, and pennants while simultaneously wearing forearm sleeve 20. Therefore, forearm sleeves 20 as a give-away item will not drive sales away from other for sale items at stadium apparel stores.

### Easy to Slide onto the Forearm

As stated above, preferably forearm sleeve 20 is a spandex/cotton blend. Therefore it is elastic and can stretch as needed so that it is easy to slide onto the forearm. For example it can fit well for a child, a thin person or even a heavy person. Also, it fits over bare skin or it can fit over a long sleeved shirt or even a bulky jacket. Because it is easy to put on despite the users size or other clothing, forearm sleeve 20 can be worn by the fan immediately after he receives it. FIG. 5 shows a section of fans at a stadium wearing forearm sleeve 20 while watching a game. This display will be seen by people at the stadium as well as people viewing the game over the television or Internet. This will be very positive advertisement for the promoter.

### Charity Donation

It was stated above that in one preferred embodiment forearm sleeves 20 are given away to sports fans free of charge as a give-away item at a sporting event. However, it is also possible to sell forearm sleeve 20 for a pre determined sales price. Forearm sleeves 20 can be sold via a variety of marketing channels. For example, forearm sleeves 20 can be sold at an actual sporting event, a retail chain store, via the Internet, or at the local market. In a preferred embodiment 20 percent of the profit made on each sale is donated to a charity of the promoter's choice. This further serves to increase the promoter's good will in the eyes of the consumer.

### Other Uses

A user of forearm sleeve 20 may decide to wear the sleeve for a variety of occasions other than attending a sports event. For example a construction worker or yard worker my want to wear forearm sleeve 20 to use to wipe sweat off his forehead while working. Or a bicycle rider may want to wear forearm sleeve 20 while riding a bicycle in the early morning when it is cold. He then may later decide to remove forearm sleeve 20 when it warms up.

Although the above-preferred embodiments have been described with specificity, persons skilled in this art will recognize that many changes to the specific embodiments disclosed above could be made without departing from the spirit of the invention. For example, in addition to the team logo a variety of other items can be printed onto forearm sleeve 20, such as: multiple sponsor names, multiple advertiser names, names of prominent players. Therefore, the attached claims and their legal equivalents should determine the scope of the invention.

1. A hollow conical shaped forearm sleeve for sliding onto a user's forearm, comprising:
A) an elastic fabric comprising a top end and an bottom end, wherein said top end and said bottom end are sewn together to form said hollow, conical shaped forearm sleeve,
B) at least one printed sports image printed onto said forearm sleeve, wherein said printed sports image is representative of a sports team,
C) an autograph receiving area on said forearm sleeve, wherein said autograph receiving area is for receiving at least one autograph, and
D) a name of at least one advertiser printed onto said forearm sleeve,
wherein said forearm sleeve is distributed to the user prior to a sports event, wherein the forearm sleeve is worn by the user at the sports event, and wherein said name of the advertiser and said sports image is viewed by others at the sports event.

2. (canceled)

3. The forearm sleeve as in claim 1, wherein said at least one advertiser is at least one promoter.

4. The forearm sleeve as in claim 1, wherein said elastic fabric is a spandex/cotton blend.

5. The forearm sleeve as in claim 1, wherein said distribution of said forearm sleeve is accomplished so that said forearm sleeve is a give-away item at a sports event.

6. The forearm sleeve as in claim 1, wherein said distribution of said forearm sleeve is accomplished so that said forearm sleeve is sold for a profit.

7. The forearm sleeve as in claim 6, wherein a percentage of said profit is donated to a charity.

8. A method for advertising an advertiser's business at a sports event, comprising the steps of:
A) distributing a forearm sleeve to a user prior to said sports event, wherein said forearm sleeve comprises:
1) an elastic fabric comprising a top end and an bottom end, wherein said top end and said bottom end are sewn together to form said hollow, conical shaped forearm sleeve,
2) at least one printed sports image printed onto said forearm sleeve, wherein said printed sports image is representative of a sports team,
3) an autograph receiving area on said forearm sleeve, wherein said autograph receiving area is for receiving at least one autograph, and
4) a name of at least one advertiser printed onto said forearm sleeve,
B) wearing said forearm sleeve at the sports event,
C) viewing said advertiser's name and said sports image on said forearm sleeve at the sports event.

9. The method as in claim 8, wherein said at least one advertiser is at least one promoter.

10. The method as in claim 8, wherein said elastic fabric is a spandex/cotton blend.

11. The method as in claim 8, wherein said distribution of said forearm sleeve is accomplished so that said forearm sleeve is a give-away item at a sports event.

12. The method as in claim 8, wherein said distribution of said forearm sleeve is accomplished so that said forearm sleeve is sold for a profit.

13. The method as in claim 12, wherein a percentage of said profit is donated to a charity.

14. The method as in claim 8, further comprising the steps of:
A) repeatedly wearing said forearm sleeve, and
B) repeatedly viewing the sports image and the advertiser's name on forearm sleeve, so that the advertiser continuously receives additional advertising without having to pay additional money.

15. The method as in claim 14 wherein said step of repeatedly wearing said forearm sleeve occurs at multiple sports events.

16. The method as in claim 14, wherein said step of repeatedly wearing occurs at events other than sports events.
